(19) United States
(12) Patent Application Publication
(10) Pub. No.: US 2015/0193068 A1
(43) Pub. Date: Jul. 9, 2015

(54) METHOD AND APPARATUS FOR SENSING TOUCH PRESSURE OF TOUCH PANEL AND TOUCH SENSING APPARATUS USING THE SAME

(71) Applicant: SAMSUNG ELECTRO-MECHANICS CO., LTD., Suwon-Si (KR)

(72) Inventor: Ji Hoon KIM, Suwon-Si (KR)

(73) Assignee: SAMSUNG ELECTRO-MECHANICS CO., LTD., Suwon-Si (KR)

(21) Appl. No.: 14/581,273

(22) Filed: Dec. 23, 2014

(30) Foreign Application Priority Data
Jan. 3, 2014 (KR) 10-2014-0000757

(51) Int. Cl. G06F 3/041

(52) U.S. Cl. CPC G06F 3/0414

(57) ABSTRACT

Disclosed herein is a method for sensing a touch pressure of a touch panel, including: sensing a bending time of a touch panel based on touch sensing signals; and determining a touch pressure based on the touch sensing signals at the bending time and a current touch sensing signal, thereby extracting information on the touch pressure without using a pressure sensor and applying the extracted pressure information to determine a gesture and to be used in various user applications.

### CROSS REFERENCE TO RELATED APPLICATION

This application claims the benefit of Korean Patent Application No. 10-2014-0000757, filed on Jan. 3, 2014, entitled “Method And Apparatus For Sensing Touch Pressure Of Touch Panel And Touch Sensing Apparatus Using The Same” which is hereby incorporated by reference in its entirety into this application.

### BACKGROUND OF THE INVENTION

1. Technical Field

The present invention relates to a method and an apparatus for sensing a touch pressure of a touch panel and a touch sensing apparatus using the same.

2. Description of the Related Art

A touch screen technology is being developed day by day and has a large market scale. Further, the use of the touch screen technology has been expanded from a small apparatus such as a smart phone to a large apparatus such as a PC monitor. Touch screen control IC makers have developed a technology for obtaining a rapid operation speed, a technology for reducing noise, and the like for a large panel. As such, as the application of the touch screen technology to a large panel of a touch screen panel is expanded, a touch control IC capable of generating various types of additional information and an algorithm included therein are required.

A capacitance is formed between a touch panel and a display apparatus, such as an LCD module disposed at a lower portion of the touch panel, and a distribution of capacitance when the touch panel is bent to the display apparatus is different from a distribution of capacitance when the touch panel is not bent to the display apparatus. The phenomenon is changed depending on a bent degree of the touch panel which is applied with a pressure.

As the touch panel is large, the bending phenomenon has grown serious. Generally, a method for compensating for a change in capacitance depending on the bending using technologies, such as digital filtering has been used.

Further, to sense a touch pressure in the touch panel, a stylus pen, and the like to which a pressure sensor is attached has been used and in the case of a general finger touch, the touch pressure is not directly sensed.

Patent Document described in the following Prior Art Document relates to a touch screen input device based on detecting of a contact time of a stylus pen and, more particularly, discloses a touch screen input device based on detecting of a contact time of a stylus pen capable of differentiating a contact of the stylus pen generating a contact sensing signal from a contact of a hand gripping the stylus pen to be able to optionally receive only an input through the contact of the stylus pen. However, according to the following Patent Document, since there is a need to sense a size of the contact pressure of a pen tip at the time of the contact of the stylus pen and provide the sensed size of the contact pressure to a terminal, there is a need to use a separate stylus pen including a pressure sensor to sense the touch pressure.

### PRIOR ART DOCUMENT

[Patent Document]

(Patent Document 1) KR10-2013-0136683 A

### SUMMARY OF THE INVENTION

The present invention has been made in an effort to provide a method for sensing a touch pressure of a touch panel capable of extracting information on the touch pressure without using a pressure sensor and applying the extracted pressure information to a gesture and various user applications.

Further, the present invention has been made in an effort to provide an apparatus for sensing a touch pressure of a touch panel capable of extracting information on the touch pressure without using a pressure sensor and applying the extracted pressure information to a gesture and various user applications.

In addition, the present invention has been made in an effort to provide a touch sensing apparatus capable of extracting information on the touch pressure without using a pressure sensor and applying the extracted pressure information to a gesture and various user applications.

According to a preferred embodiment of the present invention, there is provided a method for sensing a touch pressure of a touch panel, including: sensing a bending time of a touch panel based on touch sensing signals; and determining a touch pressure based on the touch sensing signals at the bending time and a current touch sensing signal.

The determining of the touch pressure may include determining the touch pressure based on a difference between an area of the touched region at the bending time and an area of a currently touched region.

The area of the touched region may include the number of nodes at which the touch sensing signals exceeding a predetermined threshold value are sensed.

The determining of the touch pressure may include determining the touch pressure based on a difference between a maximum value among sizes of the touch sensing signals sensed at nodes within the touched region at the bending time and a maximum value among sizes of the touch sensing signals sensed at nodes within a currently touched region.

The determining of the touch pressure may include determining the touch pressure based on a difference between an area of the touched region at the bending time and an area of a currently touched region and a difference between a maximum value among sizes of the touch sensing signals sensed at nodes within the touched region at the bending time and a maximum value among sizes of the touch sensing signals sensed at nodes within the currently touched region.

The sensing of the bending time of the touch panel may include sensing the bending time by differentiating a change in the touched area depending on the progress of the touch in the state in which the touch panel is not bent from a change in the touched area depending on the bending of the touch panel

The sensing of the bending time of the touch panel may include: calculating a standard deviation of sizes of the touch sensing signals sensed at nodes belonging to the touched region; calculating an area of the touched region; determining a maximum value among the sizes of the touch sensing signals sensed at the nodes belonging to the touched region; calculating an average value of the sizes of the touch sensing signals sensed at the nodes belonging to the touched region; determining whether the standard deviation or the average value is reduced while the maximum value is increased and the touched area is increased; and sensing the time when the standard deviation or the average value is reduced while the maximum value is increased and the touched area is increased as the bending time of the touch panel.

The sensing of the bending time of the touch panel may include: calculating a variance of sizes of the touch sensing signals sensed at nodes belonging to the touched region; calculating an area of the touched region; determining a maximum value among the sizes of the touch sensing signals sensed at the nodes belonging to the touched region; calculating an average value of the sizes of the touch sensing signals sensed at the nodes belonging to the touched region; determining whether the variance or the average value is reduced while the maximum value is increased and the touched area is increased; and sensing the time when the variance or the average value is reduced while the maximum value is increased and the touched area is increased as the bending time of the touch panel.

A gesture of a user may be determined based on a change in the determined touch pressure.

The method for sensing a touch pressure of a touch panel may further include: after the determining of the touch pressure, comparing the area of the currently touched region with the area of the touched region at the bending time; if it is determined that the area of the currently touched region is larger than that of the touched region at the bending time, outputting the determined touch pressure value; and if it is determined that the area of the currently touched area is not larger than that of the touched region at the bending time, ending the sensing of the touch pressure by considering that the bending of the touch panel is recovered to an original state.

The method for sensing a touch pressure of a touch panel may further include: after the determining of the touch pressure, comparing the maximum value among the sizes of the touch sensing signals sensed at the nodes within a currently touched region with the maximum value among the sizes of the touch sensing signals sensed at the nodes within the touched region at the bending time; if it is determined that the maximum value among the sizes of the touch sensing signals sensed at the nodes within a currently touched region is larger than the maximum value among the sizes of the touch sensing signals sensed at the nodes within the touched region at the bending time, outputting the determined touch pressure value; and if it is determined that the maximum value among the sizes of the touch sensing signals sensed at the nodes within a currently touched region is not larger than the maximum value among the sizes of the touch sensing signals sensed at the nodes within the touched region at the bending time, ending the sensing of the touch pressure by considering that the bending of the touch panel is recovered to an original state.

According to another preferred embodiment of the present invention, there is provided an apparatus for sensing a touch pressure of a touch panel, including: a bending time sensing unit sensing a bending time of a touch panel based on touch sensing signals; and when the bending time sensing unit senses that the touch panel is bent, a touch pressure determination unit determining the touch pressure based on the touch sensing signals at the bending time and a current touch sensing signal.

The touch pressure determination unit may determine the touch pressure based on a difference between an area of the touched region at the bending time and an area of a currently touched region.

The area of the touched region may include the number of nodes at which the signals exceeding a predetermined threshold value are sensed.

The touch pressure determination unit may determine the touch pressure based on a difference between a maximum value among sizes of the touch sensing signals sensed at nodes within the touched region at the bending time and a maximum value among sizes of the touch sensing signals sensed at nodes within a currently touched region.

The bending time sensing unit may sense the bending time by differentiating a change in the touched area depending on the progress of the touch in the state in which the touch panel is not bent from a change in the touched area depending on the bending of the touch panel.

The bending time sensing unit may include: a standard deviation calculation unit calculating a standard deviation of sizes of the touch sensing signals sensed at nodes belonging to the touched region; a touch area calculation unit calculating an area of the touched area; a maximum value determination unit determining a maximum value among sizes of the touch sensing signals sensed at the nodes belonging to the touched region; an average value calculation unit calculating an average value of sizes of the touch sensing signals sensed at nodes belonging to the touched region; and a bending time determination unit determining whether the standard deviation or the average value is reduced while the maximum value is increased and the touched area is increased and determining the time when the standard deviation or the average value is reduced while the maximum value is increased and the touched area is increased as the bending time of the touch panel.

The bending time sensing unit may include: a standard deviation calculation unit calculating a variance of sizes of the touch sensing signals sensed at nodes belonging to the touched region; a touch area calculation unit calculating an area of the touched region; a maximum value determination unit determining a maximum value among sizes of the touch sensing signals sensed at the nodes belonging to the touched region; an average value calculation unit calculating an average value of sizes of the touch sensing signals sensed at nodes belonging to the touched region; a bending time determination unit determining whether the variance or the average value is reduced while the maximum value is increased and the touched area is increased and determining the time when the variance or the average value is reduced while the maximum value is increased and the touched area is increased as the bending time of the touch panel.

A gesture of a user may be determined based on a change in the determined touch pressure.

According to still another preferred embodiment of the present invention, there is provided a touch sensing apparatus, including: a touch panel sensing a touch of a user; a driving unit applying a driving signal to a driving electrode of the touch panel; a sensing unit receiving an output from a sensing electrode of the touch panel; a signal conversion unit converting the output from the sensing unit into a voltage signal; and a control unit sensing a bending time of the touch panel based on touch sensing signals output from the signal conversion unit and determining a touch pressure based on the touch sensing signals at the bending time and a currently touched sensing signal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a first experimental data for describing an operation principle of an apparatus and a method for sensing a touch pressure of a touch panel according to a preferred embodiment of the present invention;

FIG. 2 is a second experimental data for describing an operation principle of an apparatus and a method for sensing a touch pressure of a touch panel according to a preferred embodiment of the present invention;

FIG. 3 is a third experimental data for describing an operation principle of an apparatus and a method for sensing a touch pressure of a touch panel according to a preferred embodiment of the present invention;

FIG. 4 is a fourth experimental data for describing an operation principle of an apparatus and a method for sensing a touch pressure of a touch panel according to a preferred embodiment of the present invention;

FIGS. 5A to 5C are graphs for describing an operation principle of the apparatus and method for sensing a touch pressure of a touch panel according to the preferred embodiment of the present invention;

FIG. 6 is a block diagram of a touch sensing apparatus to which the apparatus and method for sensing a touch pressure of a touch panel according to the preferred embodiment of the present invention are applied;

FIG. 7 is a block diagram of the apparatus for sensing a touch pressure of a touch panel according to the preferred embodiment of the present invention;

FIG. 8 is a flow chart of the method for sensing a touch pressure of a touch panel according to the preferred embodiment of the present invention; and

FIG. 9 is a detailed flow chart of a process of sensing a bending time of the touch panel illustrated in FIG. 8.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

Operation Principle According to One Preferred Embodiment of the Invention

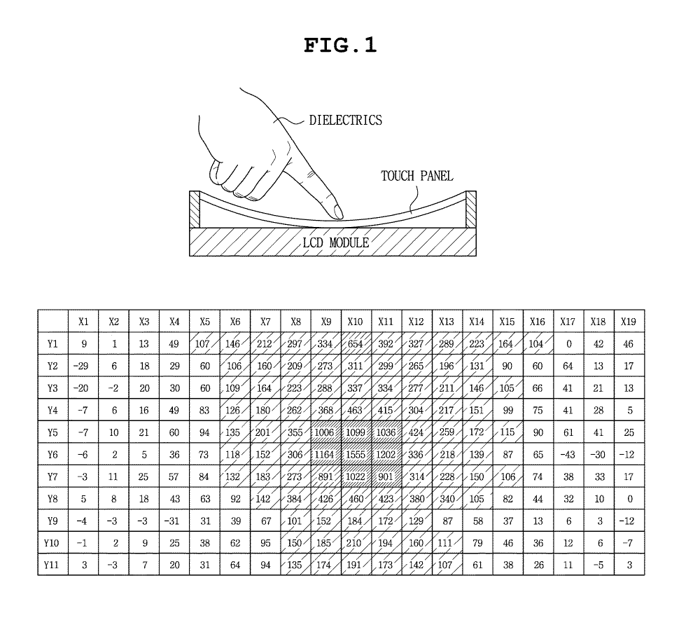

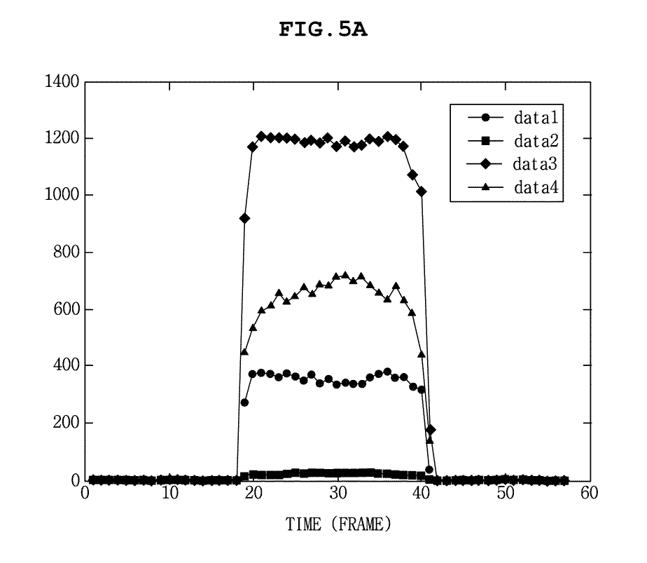

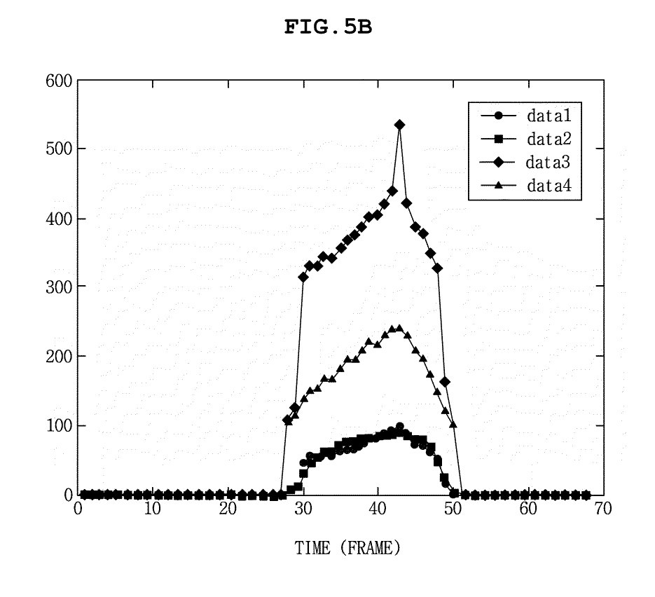

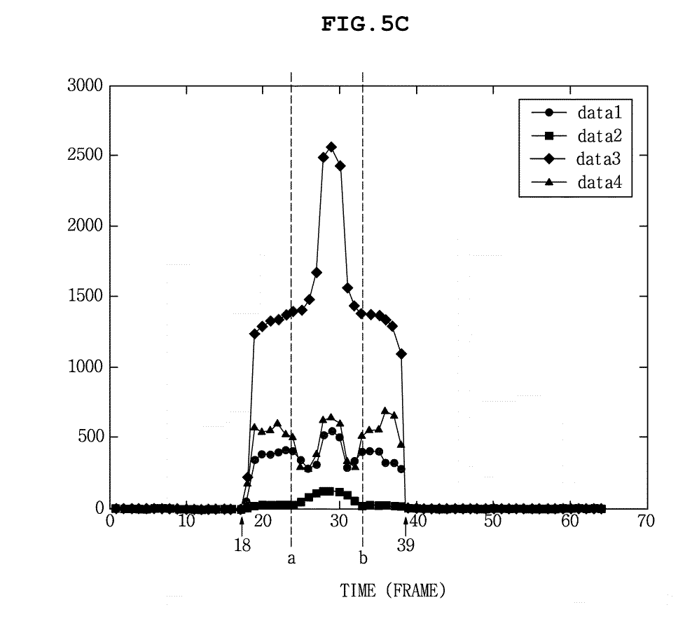

FIGS. 1 to 4 are first to fourth experimental data for describing an operation principle of an apparatus and a method for sensing a touch pressure of a touch panel according to a preferred embodiment of the present invention and FIGS. 5A to 5C are graphs for describing an operation principle of the apparatus and method for sensing a touch pressure of a touch panel according to the preferred embodiment of the present invention.

First, the operation principle of the apparatus and method for sensing a touch pressure of a touch panel according to the preferred embodiment of the present invention will be described with reference to FIGS. 1 to 4 and FIGS. 5A to 5C.

According to one preferred embodiment of the present invention, a bending time of a touch panel and a bent degree of the touch panel are sensed and the sensed bending time and bent degree are used as touch pressure information.

The experimental data illustrated in FIGS. 1 to 4 are data obtained by a real experiment and are experimental data supporting the operation principle of the apparatus and method for sensing a touch pressure of a touch panel according to the preferred embodiment of the present invention.

The obtained experimental data may be changed depending on noise environment, a size of the touch panel, an interval between the touch panel and a display such as an LCD module, and characteristics of physical bending of the touch panel and the experimental data illustrated in FIGS. 1 to 4 may have different distributions depending on the situation in consideration of various environments but may be referenced as data standing for common tendency.

FIG. 1 illustrates a distribution of signal intensity sensed by a touch sensor such as a sensing electrode of the touch panel when the touch panel is bent in a direction of the display such as the LCD module when being touched by dielectrics such as a finger. In FIG. 1, a portion at which the signal intensity is strong is represented thickly and a portion at which the signal intensity is weak is represented thinly

As illustrated in FIG. 1, when the touch panel is bent in the direction of the display, it may be appreciated that a signal is sensed by the touch sensor depending on a change in a distribution of capacitance between the touch panel and the display over a wide area from a touched portion to a circumference thereof.

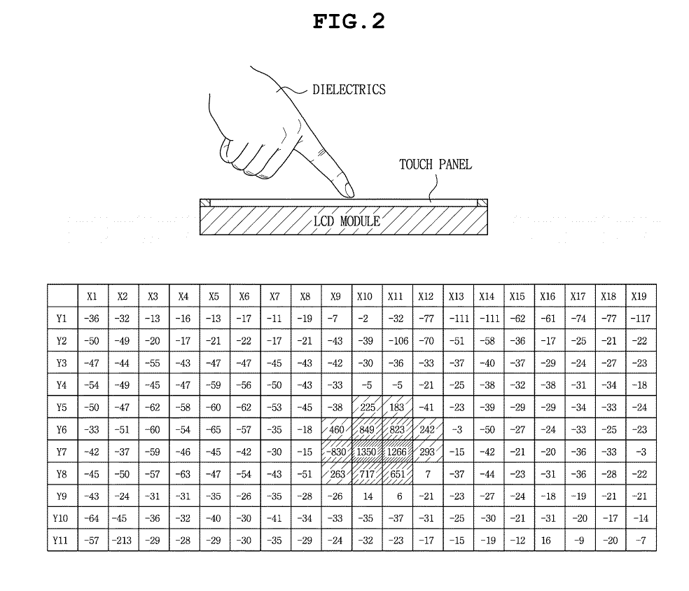

FIG. 2 illustrates the distribution of the signal intensity obtained by applying a strong pressure to the touch panel in the state in which the touch panel is touched due to the dielectrics such as finger but the touch panel is not bent.

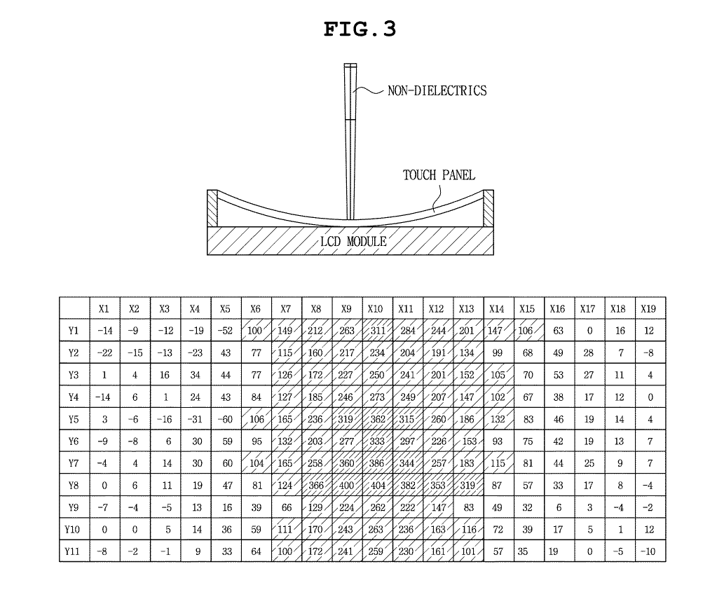

FIG. 3 illustrates the distribution of the signal intensity appearing while the touch panel is bent, when the touch panel is strongly pressed by non-dielectrics such as tree. It may be appreciated that the distribution of the touch signal appears like the case in which the touch panel is physically bent.

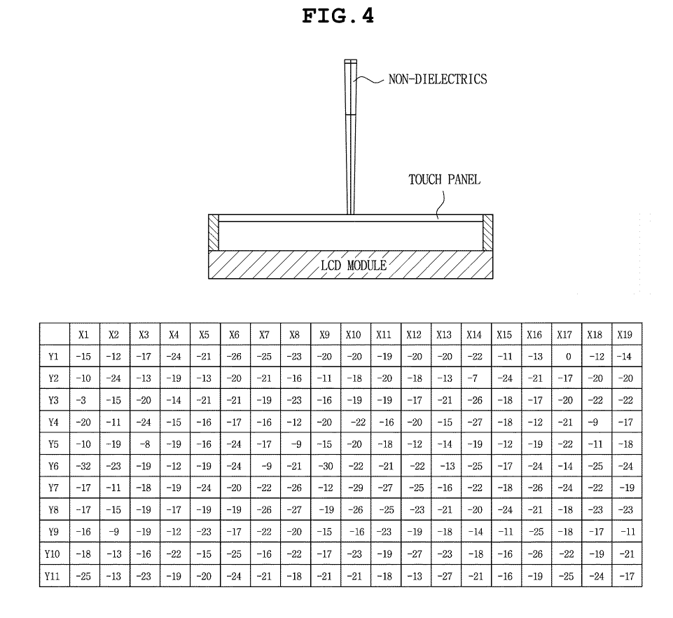

FIG. 4 illustrates the distribution of the signal intensity appearing when the touch panel is touched by non-dielectrics such as tree. It may be appreciated that the touch signal is not detected in the state in which the touch panel is not bent, when the touch panel is touched.

Referring to FIGS. 3 and 4, when the touch panel is touched only by the non-dielectrics, that is, when the touch panel is touched by the non-dielectrics so as to prevent the touch panel from being bent, the touch signal is not sensed, but when the touch panel is pressed by the non-dielectrics so as to bend the touch panel, it may be appreciated that the distribution of the capacitance between the touch panel and the LCD module is changed due to the bending of the touch panel and thus the touch signal is sensed.

As a result, it may be appreciated that the distribution of the signal intensity appearing when the touch panel is pressed by a finger as illustrated in FIG. 1 is formed by overlapping the distribution of the touch signal intensity of FIG. 2 with the distribution of the touch signal intensity of FIG. 3.

FIGS. 1 to 4 illustrate characteristics of the touch signal intensity acquired at a specific time. The operation principle according to one preferred embodiment of the present invention will be described based on characteristics which are changed over time depending on the touch pressure.

FIG. 5A is a graph obtained by analyzing characteristics of the touched region depending on time which is measured under the environment of FIG. 2.

In FIG. 5A, a horizontal axis represents a time represented by a frame and a vertical axis represents the number of nodes which exceeds a predetermined threshold value. In FIG. 5A, the vertical axis represents a standard deviation of sizes of touch sensing signals sensed at the nodes within the touched region and represents a maximum value among the sizes of the touch sensing signals sensed at the nodes within the touched region or an average value of the touch sensing signals sensed at the nodes within the touched region.

In FIG. 5A, data1 may represent the standard deviation of the sizes of the touch sensing signals sensed at the nodes within the touched region and data2 may represent an area of the touched region which may represent the number of nodes exceeding the predetermined threshold value.

In FIG. 5A, data3 represents a maximum value among the sizes of the touch sensing signals sensed at the nodes within the touched region and data4 represents an average value of the touch sensing signals sensed at the nodes within the touched region.

In FIG. 5A, the features of the touched region are analyzed as follows.

0th to 20th frames and 40th to 60th frames are a section in which the touch is not generated, 20th to 30th frames are a section in which the touch pressure is increased, and 30th to 40th frames are a section in which the touch pressure is reduced.

Referring to FIG. 5A, it may be appreciated that the touch pressure is proportional to the data2 and the data4. However, since the tendency of data2 and data4 has characteristics which are proportional to the touched area (palm touch, and the like), it is not accurate to determine the touch pressure with the tendency of data2 and data4. The reason is that it is difficult to differentiate the case in which the touch slowly approaches the touch panel and thus the touched area is substantially increased by the pressing from the case in which the touch pressure is increased and thus the touch panel is bent. Therefore, the data of FIG. 5A may not be a determination criterion which senses the touch pressure.

FIG. 5B illustrates the features of the touched region depending on time which is measured under the environment of FIG. 3.

0th to 27th frames and 50th to 70th frames are a section in which the touch is not generated, 28th to 43th frames are a section in which the bent degree is increased due to the non-dielectrics, and 44th to 50th frames are a section in which the bent degree is reduced due to the non-dielectrics.

In FIG. 5B, data1 represents a standard deviation of sizes of touch sensing signals sensed at the nodes within the touched region and data2 represents an area of a touched region which represents the number of nodes exceeding the predetermined threshold value.

In FIG. 5B, data3 represents a maximum value among the sizes of the touch sensing signals sensed at the nodes within the touched region and data4 represents an average value of the touch sensing signals sensed at the nodes within the touched region.

In FIG. 5B, the touch pressure and the data1, data2, data3, and data4 have proportional characteristics.

As illustrated in FIG. 1 described above, it may be appreciated that the distribution of the signal intensity appearing when the touch panel is pressed by a finger as illustrated in FIG. 1 is formed by overlapping the distribution of the touch signal intensity of FIG. 2 with the distribution of the touch signal intensity of FIG. 3.

Therefore, the overlapping of the graphs appearing the characteristics of the touched region depending on time in the situations illustrated in FIGS. 2 and 3, respectively, may acquire the same features as the touched region depending on time which is acquired in one preferred embodiment of the present invention in the situation illustrated in FIG. 1.

FIG. 5C is a graph obtained by overlapping the graphs showing the characteristics of the touched region depending on time in the situations illustrated in FIGS. 2 and 3.

In FIG. 5C, data1 represents a standard deviation of sizes of touch sensing signals sensed at the nodes within the touched region and data2 represents an area of a touched region which represents the number of nodes exceeding the predetermined threshold value.

In FIG. 5C, data3 represents a maximum value among the sizes of the touch sensing signals sensed at the nodes within the touched region and data4 represents an average value of the touch sensing signals sensed at the nodes within the touched region.

In FIG. 5C, the features of the touched region are analyzed as follows.

0th to 18th frames and 39th to 70th frames are a section in which the touch is not generated, 18th to 29th frames are a section in which the touch pressure is increased, and 29th to 39th frames are a section in which the touch pressure is reduced.

In FIG. 5C, a represents the bending time when the bending occurs due to the touch pressure and b represents the time when a recovery of the bending ends due to the touch pressure.

As may be appreciated from FIG. 5C, the time of a, that is, the bending time is the time when the data2 starts to increase, with the reduction in the data4 or the tendency that the data4 is reduced while the data3 is increased.

That is, the bending time is (1) the time when the average value of the touch sensing signals sensed at the nodes within the touched region is reduced or has a tendency to be reduced while the maximum value among the sizes of the touch sensing signals sensed at the nodes within the touched region is increased and (2) the time when the area of the touched region, that is, the number of nodes exceeding the predetermined threshold value starts to be increased.

The bending time of the touch panel may be sensed under the above conditions (1) and (2). Instead of the standard deviation as described above, the bending time of the touch panel may also be sensed using variance.

As described above, sensing the bending time may differentiate the features that the area is changed depending on the contact area of the touch and the change in the area due to the bending.

The increase in the touched area after the bending time is sensed may be determined as the increase in the touch pressure and therefore the touched area at the time of the bending is used as a reference value of the touch which increases in the future. Therefore, the difference between the reference value and the increasing area may be determined as the touch pressure.

Similarly, the maximum value data3 among the size of the touch sensing signals sensed at the nodes within the touched region may also be converted into a touch pressure value and the touch pressure value may also be represented by a combination of the area data2 of the touched region and the maximum value data3 among the sizes of the touch sensing signals sensed at the nodes within the touched region.

### EMBODIMENT

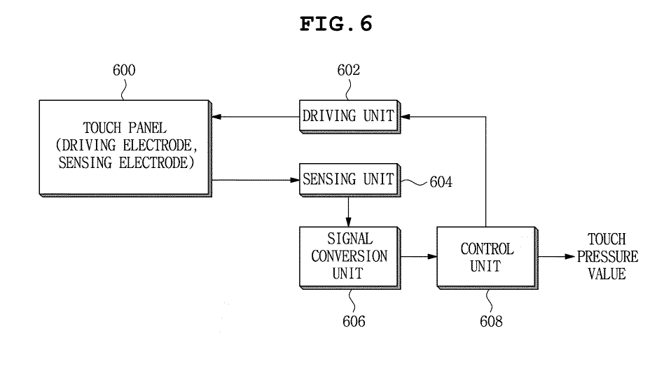

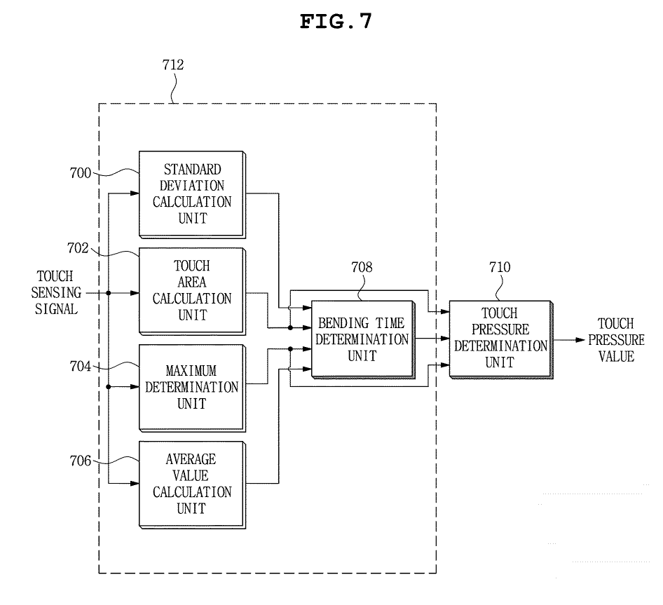

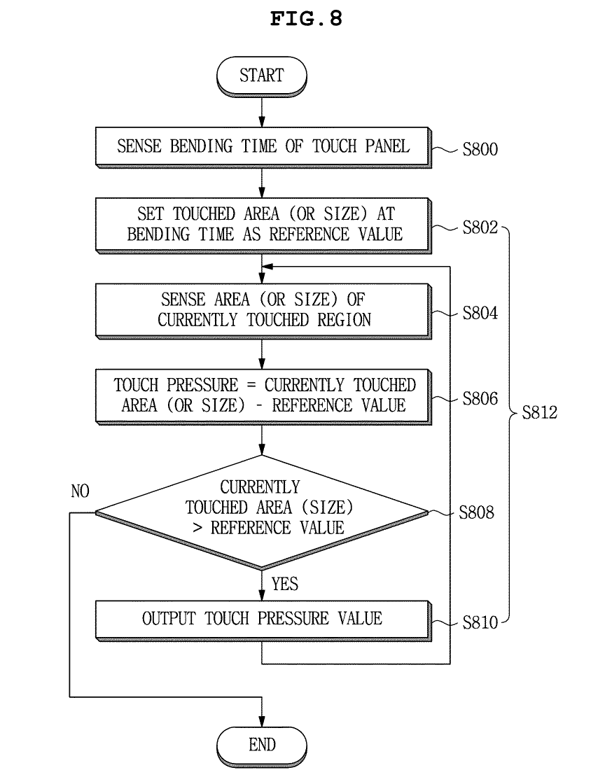

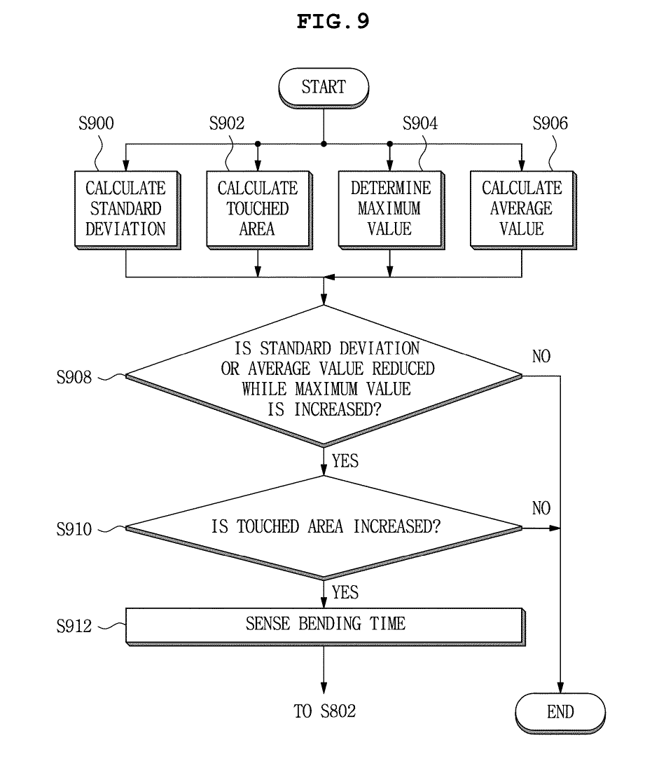

FIG. 6 is a block diagram of a touch sensing apparatus to which the apparatus and method for sensing a touch pressure of a touch panel according to the preferred embodiment of the present invention are applied, FIG. 7 is a block diagram of the apparatus for sensing a touch pressure of a touch panel according to the preferred embodiment of the present invention, FIG. 8 is a flow chart of the method for sensing a touch pressure of a touch panel according to the preferred embodiment of the present invention, and FIG. 9 is a detailed flow chart of a process of sensing a bending time of the touch panel illustrated in FIG. 8.

The apparatus and method for sensing a touch pressure of a touch panel according to the preferred embodiment of the present invention will be described below with reference to FIGS. 6 to 9.

The touch sensing apparatus to which the apparatus and method for sensing a touch pressure of a touch panel according to the preferred embodiment of the present invention illustrated in FIG. 6 are applied includes: a touch panel 600 for sensing a touch of a user; a driving unit 602 for applying a driving signal to a driving electrode of the touch panel 600; a sensing unit 604 for receiving an output from a sensing electrode of the touch panel 600; a signal conversion unit 606 for converting the output from the sensing unit 604 into a voltage signal; and a control unit 608 for sensing the bending time of the touch panel 600 based on the touch sensing signal output from the signal conversion unit 606 and determining the touch pressure based on the touch sensing signal at the bending time and the current touch sensing signal.

The control unit 608 illustrated in FIG. 6 may perform the method for sensing a touch pressure of a touch panel according to the preferred embodiment of the present invention and the method for sensing a touch pressure of a touch panel according to the preferred embodiment of the present invention illustrated in FIGS. 8 and 9 is stored in a predetermined memory in a program form and may be performed in a software form by the control unit 608.

Alternatively, the method for sensing a touch pressure of a touch panel according to the preferred embodiment of the present invention illustrated in FIGS. 8 and 9 may be implemented and performed in a hardware form by a bending time sensing unit 712 for allowing the touch panel 600 to sense the bending time based on the touch sensing signal and when the bending time sensing unit 712 senses that the touch panel 600 is bent, a touch pressure determination unit 710 for determining the touch pressure based on the touch sensing signal at the bending time and the current touch sensing signal.

The bending time sensing unit 712 may include a standard deviation calculation unit 700 for calculating the standard deviation of the sizes of the touch sensing signals sensed at the nodes belonging to the touched region; a touch area calculation unit 702 for calculating the area of the touched region, a maximum value determination unit 704 for determining the maximum value among the sizes of the touch sensing signals sensed at the nodes belonging to the touched region; an average value calculation unit 706 for calculating the average value of the sizes of the touch sensing signals sensed at the nodes belonging to the touched region; and a bending time determination unit 708 for determining whether the standard deviation or the average value is reduced while the maximum value is increased and the touched area is increased and determining the time when the standard deviation or the average value is reduced while the maximum value is increased and the touched area is increased as the bending time of the touch panel.

The operation of the apparatus and method for sensing a touch pressure of a touch panel according to the preferred embodiment of the present invention will be described below.

It is assumed that the user touches a predetermined point of the touch panel 600 with his/her finger and applies a pressure.

First, the case in which the method for sensing a touch pressure of a touch panel according to the preferred embodiment of the present invention illustrated in FIGS. 8 and 9 is stored in the predetermined memory in the program form and is performed in a software form by the control unit 608 will be described.

In step S800, the control unit 608 senses the bending time of the touch panel 600 based on the touch sensing signal output from the signal conversion unit 606. In step S812, the control unit 608 determined the touch pressure based on the touch sensing signal at the bending time and the current touch sensing signal.

In step S800, a process of allowing the control unit 608 to determine the bending time will be described in more detail with reference to FIG. 9.

In step S900 the control unit 608 calculates the standard deviation of the sizes of the touch sensing signals sensed at the nodes belonging to the touched region, in step S902 the area of the touched region is calculated, in step S904 the maximum value among the sizes of the touch sensing signals sensed at the nodes belonging to the touched region is determined, in step S906 the average value of the sizes of the touch sensing signals sensed at the nodes belonging to the touched region is calculated, in step S908 it is determined whether the standard deviation or the average value is reduced while the maximum value is increased and if it is determined in step S908 that the standard deviation or the average value is reduced while the maximum value is increased, in step 912 it is determined whether the touched area is increased, and in step S912 the time when the standard deviation or the average value is reduced and the touched area is increased while the maximum value is increased is sensed as the bending time.

In FIG. 8, in the sensing of the bending time (S800), the bending time may be sensed by differentiating the change in the touched area depending on the progress of the touch in the state in which the touch panel 600 is not bent from the change in the touched area depending on the bending of the touch panel 600.

Further, when the bending time of the touch panel 600 is sensed, the bending time of the touch panel may also be sensed based on the variance of the sizes of the touch sensing signals sensed at the nodes belonging to the touched region instead of the standard deviation.

Meanwhile, the determining of the touch pressure (S812) by the control unit 608 based on the touch sensing signal at the bending time and the current touch sensing signal will be described in more detail.

The control unit 608 sets the touched area at the bending time as the reference value in step S802, senses the area of the currently touched region in step S804, determines a value obtained by subtracting the reference value from the currently touched area as the touch pressure in step S806, determines whether the currently touched area is larger than the reference value in step S808, and if it is determined that the currently touched area is larger than the reference value in step S808, outputs the touch pressure value in step S810. If the control unit 608 determines that the area of the currently touched region is not larger than that of the touched region at the bending time in step S808, it is considered that the bending of the touch panel 600 is recovered to the original state and the sensing of the touch pressure ends.

In the above description, the touched area is the area of the touched region and may represent the number of nodes exceeding the predetermined threshold value.

Although the touch pressure is determined based on the touched area in step S812, one preferred embodiment of the present invention is not limited thereto and the touch pressure may also be determined based on the maximum value among the sizes of the touch sensing signals sensed at the nodes within the touched region.

That is, in step S812, the touch pressure may be determined based on the difference between the maximum value among the sizes of the touch sensing signals sensed at the nodes within the touched region at the bending time and the maximum value among the sizes of the touch sensing signals sensed at the nodes within the currently touched region.

Further, in the determining of the touch pressure in step S812, the touch pressure may also be determined based on the difference between the area of the touched region at the bending time and the area of the currently touched region and the difference between the maximum value among the sizes of the touch sensing signals sensed at the nodes within the touched region at the bending time and the maximum value among the sizes of the touch sensing signals sensed at the nodes within the currently touched region.

When the touch pressure is determined as described above, the determined touch pressure may determine a gesture of the user or may be used in various user applications.

Meanwhile, the operation of the case in which the method for sensing a touch pressure of a touch panel according to the preferred embodiment of the present invention illustrated in FIGS. 8 and 9 is implemented and performed in the hardware form by the bending time sensing unit 712 and the touch pressure determination unit 710 illustrated in FIG. 7 will be described below.

The standard deviation calculation unit 700 calculates the standard deviation of the sizes of the touch sensing signals sensed at the nodes belonging to the touched region, the touch area calculation unit 702 calculates the area of the touched region, the maximum value determination unit 704 determines the maximum value among the sizes of the touch sensing signals sensed at the nodes belonging to the touched region, and the average value calculation unit 706 calculates the average value of the sizes of the touch sensing signals sensed at the nodes belonging to the touched region.

The bending time determining unit 708 determines the time when the standard deviation or the average value is reduced and while the maximum value is increased and the touched area is increased and determines the standard deviation or the average value is reduced while the maximum value is increased and the touched area is increased as the bending time of the touch panel 600.

The touch pressure determination unit 710 determines the touch pressure based on the output of the bending time determination unit 708 and the touch area calculation unit 702.

The touch pressure determination unit 710 sets the touch area of the bending time output from the touch area calculation unit 702 as the reference value at the moment that the bending time is sensed by the bending time determination unit 708, senses the area of the currently touched region output from the touch area calculation unit 702, and determines the value obtained by subtracting the reference value from the currently touched area as the touch pressure.

In the above description, the touched area is the area of the touched region and may represent the number of nodes exceeding the predetermined threshold value.

Although the touch pressure determination unit 710 determines the touch pressure based on the touched area, one preferred embodiment of the present invention is not limited thereto and the touch pressure may also be determined based on the maximum value among the sizes of the touch sensing signals sensed at the nodes within the touched region.

That is, the touch pressure determination unit 710 may determine the touch pressure based on the difference between the maximum value among the sizes of the touch sensing signals sensed at the nodes within the touched region at the bending time and the maximum value among the sizes of the touch sensing signals sensed at the nodes within the currently touched region.

When the touch pressure is determined as described above, the determined touch pressure may determine the gesture of the user or may be used in various user applications.

The method and apparatus for sensing a touch pressure of a touch panel and the touch sensing apparatus using the same according to the preferred embodiment of the present invention may be applied to the algorithm embedded in the touch screen integrated circuit and in particular, may be used in a medium and large sized touch panel which may be easily bent.

According to the exemplary embodiment of the present invention, it is possible to extract the information on the touch pressure without using the pressure sensor and apply the extracted pressure information to determine the gesture and to be used in various user applications.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A method for sensing a touch pressure of a touch panel, the method comprising:
sensing a bending time of a touch panel based on touch sensing signals; and
determining a touch pressure based on the touch sensing signals at the bending time and a current touch sensing signal.

2. The method as set forth in claim 1, wherein the determining of the touch pressure includes determining the touch pressure based on a difference between an area of the touched region at the bending time and an area of a currently touched region.

3. The method as set forth in claim 2, wherein the area of the touched region includes the number of nodes at which the touch sensing signals exceeding a predetermined threshold value are sensed.

4. The method as set forth in claim 1, wherein the determining of the touch pressure includes determining the touch pressure based on a difference between a maximum value among sizes of the touch sensing signals sensed at nodes within the touched region at the bending time and a maximum value among sizes of the touch sensing signals sensed at nodes within a currently touched region.

5. The method as set forth in claim 1, wherein the determining of the touch pressure includes determining the touch pressure based on a difference between an area of the touched region at the bending time and an area of a currently touched region and a difference between a maximum value among sizes of the touch sensing signals sensed at nodes within the touched region at the bending time and a maximum value among sizes of the touch sensing signals sensed at nodes within the currently touched region.

6. The method as set forth in claim 1, wherein the sensing of the bending time of the touch panel includes sensing the bending time by differentiating a change in the touched area depending on the progress of the touch in the state in which the touch panel is not bent from a change in the touched area depending on the bending of the touch panel.

7. The method as set forth in claim 1, wherein the sensing of the bending time of the touch panel includes:
calculating a standard deviation of sizes of the touch sensing signals sensed at nodes belonging to the touched region;
calculating an area of the touched region;
determining a maximum value among the sizes of the touch sensing signals sensed at the nodes belonging to the touched region;
calculating an average value of the sizes of the touch sensing signals sensed at the nodes belonging to the touched region;
determining whether the standard deviation or the average value is reduced while the maximum value is increased and the touched area is increased; and
sensing the time when the standard deviation or the average value is reduced while the maximum value is increased and the touched area is increased as the bending time of the touch panel.

8. The method as set forth in claim 1, wherein the sensing of the bending time of the touch panel includes:
calculating a variance of sizes of the touch sensing signals sensed at nodes belonging to the touched region;
calculating an area of the touched region;
determining a maximum value among the sizes of the touch sensing signals sensed at the nodes belonging to the touched region;
calculating an average value of the sizes of the touch sensing signals sensed at the nodes belonging to the touched region;
determining whether the variance or the average value is reduced while the maximum value is increased and the touched area is increased; and
sensing the time when the variance or the average value is reduced while the maximum value is increased and the touched area is increased as the bending time of the touch panel.

9. The method as set forth in claim 1, wherein a gesture of a user is determined based on a change in the determined touch pressure.

10. The method as set forth in claim 2, further comprising:
after the determining of the touch pressure,
comparing the area of the currently touched region with the area of the touched region at the bending time;
if it is determined that the area of the currently touched region is larger than that of the touched region at the bending time, outputting the determined touch pressure value; and
if it is determined that the area of the currently touched area is not larger than that of the touched region at the bending time, ending the sensing of the touch pressure by considering that the bending of the touch panel is recovered to an original state.

11. The method as set forth in claim 4, further comprising:
after the determining of the touch pressure,
comparing the maximum value among the sizes of the touch sensing signals sensed at the nodes within a currently touched region with the maximum value among the sizes of the touch sensing signals sensed at the nodes within the touched region at the bending time;
if it is determined that the maximum value among the sizes of the touch sensing signals sensed at the nodes within a currently touched region is larger than the maximum value among the sizes of the touch sensing signals sensed at the nodes within the touched region at the bending time, outputting the determined touch pressure value; and
if it is determined that the maximum value among the sizes of the touch sensing signals sensed at the nodes within a currently touched region is not larger than the maximum value among the sizes of the touch sensing signals sensed at the nodes within the touched region at the bending time, ending the sensing of the touch pressure by considering that the bending of the touch panel is recovered to an original state.

12. An apparatus for sensing a touch pressure of a touch panel, the apparatus comprising:
a bending time sensing unit sensing a bending time of a touch panel based on touch sensing signals; and
when the bending time sensing unit senses that the touch panel is bent, a touch pressure determination unit determining the touch pressure based on the touch sensing signals at the bending time and a current touch sensing signal.

13. The apparatus as set forth in claim 12, wherein the touch pressure determination unit determines the touch pressure based on a difference between an area of the touched region at the bending time and an area of a currently touched region.

14. The apparatus as set forth in claim 13, wherein the area of the touched region includes the number of nodes at which the signals exceeding a predetermined threshold value are sensed.

15. The apparatus as set forth in claim 12, wherein the touch pressure determination unit determines the touch pressure based on a difference between a maximum value among sizes of the touch sensing signals sensed at nodes within the touched region at the bending time and a maximum value among sizes of the touch sensing signals sensed at nodes within a currently touched region.

16. The apparatus as set forth in claim 12, wherein the bending time sensing unit senses the bending time by differentiating a change in the touched area depending on the progress of the touch in the state in which the touch panel is not bent from a change in the touched area depending on the bending of the touch panel.

17. The apparatus as set forth in claim 12, wherein the bending time sensing unit includes:
a standard deviation calculation unit calculating a standard deviation of sizes of the touch sensing signals sensed at nodes belonging to the touched region;
a touch area calculation unit calculating an area of the touched area;
a maximum value determination unit determining a maximum value among sizes of the touch sensing signals sensed at the nodes belonging to the touched region;
an average value calculation unit calculating an average value of sizes of the touch sensing signals sensed at nodes belonging to the touched region; and
a bending time determination unit determining whether the standard deviation or the average value is reduced while the maximum value is increased and the touched area is increased and determining the time when the standard deviation or the average value is reduced while the maximum value is increased and the touched area is increased as the bending time of the touch panel.

18. The apparatus as set forth in claim 12, wherein the bending time sensing unit includes:
a standard deviation calculation unit calculating a variance of sizes of the touch sensing signals sensed at nodes belonging to the touched region;
a touch area calculation unit calculating an area of the touched region;
a maximum value determination unit determining a maximum value among sizes of the touch sensing signals sensed at the nodes belonging to the touched region;
an average value calculation unit calculating an average value of sizes of the touch sensing signals sensed at nodes belonging to the touched region; and
a bending time determination unit determining whether the variance or the average value is reduced while the maximum value is increased and the touched area is increased and determining the time when the variance or the average value is reduced while the maximum value is increased and the touched area is increased as the bending time of the touch panel.

19. The apparatus as set forth in claim 12, wherein a gesture of a user is determined based on a change in the determined touch pressure.

20. A touch sensing apparatus, comprising:
a touch panel sensing a touch of a user;
a driving unit applying a driving signal to a driving electrode of the touch panel;
a sensing unit receiving an output from a sensing electrode of the touch panel;
a signal conversion unit converting the output from the sensing unit into a voltage signal; and
a control unit sensing a bending time of the touch panel based on touch sensing signals output from the signal conversion unit and determining a touch pressure based on the touch sensing signals at the bending time and a currently touched sensing signal.
